(19) United States
(12) Patent Application Publication
(10) Pub. No.: US 2019/0207391 A1
(43) Pub. Date: Jul. 4, 2019

(54) DYNAMIC ACTIVE AND REACTIVE POWER LOAD SHARING IN AN ISLANDED MICROGRID

(71) Applicant: Swansea University, Swansea (GB)

(72) Inventors: Meghdad Fazeli, Swansea (GB); Augustine Egwebe, Swansea (GB)

(73) Assignee: Swansea University, Swansea (GB)

(21) Appl. No.: 16/325,631

(22) PCT Filed: Aug. 15, 2017
(86) PCT No.: PCT/GB2017/052403

§ 371 Date: Feb. 14, 2019

(30) Foreign Application Priority Data
Aug. 15, 2016 (GB) 1613956.0

(51) Int. Cl. H02J 3/46; H02J 3/38; H02J 3/18; H02J 3/16; H02M 7/48

(52) U.S. Cl. CPC H02J 3/46; H02J 3/383; H02J 2003/388; H02J 3/16; H02M 7/48; H02J 3/18

(57) ABSTRACT

A method of managing a microgrid and control system is provided, in which the virtual resistance control gains (in αβ frame) of each respective inverter is dynamically adjusted based on a variable related to the available power from each of a plurality of renewable distributed generators.

### CROSS-REFERENCE TO RELATED APPLICATIONS

This application claims priority to PCT Application No. PCT/GB2017/052403 filed Aug. 15, 2017, which claims the benefit of G.B. Application No. 1613956.0 filed Aug. 15, 2016, each of which is incorporated herein by reference in its entirety.

### FIELD

The present invention is concerned with a method and system for managing an islanded micro grid comprising a plurality of distributed generators. In particular, the present invention is concerned with a method and system for controlling a microgrid comprising renewable distributed generators which is less reliant on the use of a fossil-fuelled auxiliary generator.

### BACKGROUND OF THE DISCLOSURE

A reference list is provided at the end of the description. References in square brackets [ ] refer to that list, each of which is incorporated herein by reference in its entirety.

Energy generation, storage, and management within a microgrid (MG) utilising renewable distributed generators (DGs) is a global issue as attention is continually drawn away from conventional sources of energy like fossil fuel.

Modern MG configurations, consisting of various distributed generators (DG), provide more optimized capacity and control flexibilities to meet system reliability and power quality requirements [4]-[5]. MGs must be able to operate in grid-connected mode (i.e. connected to a main grid, such as the UK National Grid) or islanded mode (i.e. disconnected from the main grid). In order to balance generated energy with demand in a MG, renewable energy generation are often supplemented with dispatchable resources such as localized/globalized energy storage (ES) and auxiliary generation (AG) [5]. Absence of such resources can result in the failure of the inverter-based sources [6]-[9]. Modern approach towards improving the flexibility and reliability of the MGs favour a hybrid DG networks (comprising of renewable sources, energy storage systems (ES) and fossil-fuelled AG) [1]-[3], [10].

A practical MG network requires a fossil-fuelled AG to supply (at least) the critical loads in case of shortage of energy. The role of the AG, proposed in this patent, is not similar to that of a master unit (in a master-slave paradigm) since unlike in a master-slave control, the operations of other units are not dependent on the AG. In grid-connected MG, control measures are relatively easy to be implemented since the voltage and frequency are regulated by the grid; whereas in islanded-configuration, voltage and frequency must be actively controlled for the continuous and stable performance of the network [11]-[13]. The droop-sharing scheme adopts an autonomous load sharing approach, where each connected DG uses their local parameters (voltage and frequency) for accurate load sharing [14], [15]. The classical droop-scheme uses the power-frequency and reactive power-voltage slopes for inductive MGs [10], [16].

Reference [17] highlighted the problems with classic droop scheme as shown in FIG. 1. Classic droop sets a fixed frequency gain irrespective of the available energy from the renewable source. In such cases, a drop in the available power of one of the DGs from P1 to P1′ (e.g. due to a reduction in solar irradiation) will shift its frequency (f) to a new operating point (f*). Since the other DG must comply with the new operating frequency (f*), its power reduces from P2 to P2′ (even though it might have the capacity to generate more power) [17]. This is due to the insensitivity of the droop scheme to the varying nature of the renewable resources [17]. The author proposed a dynamic scheme which uses the DC voltage (as a function of irradiance level) changes in conditioning the droop parameters for efficient load sharing based on available generation. The dynamic method in [17] was proposed for inductive MG, however, most MGs are located in the low-voltage side of the gird (i.e. distribution level) where network is mainly resistive, hence, the proposed scheme in [17] is not applicable. Moreover, [17] did not consider the effect of the dynamic active power sharing on reactive power contribution of the units. Due to the proposed dynamic active power sharing, one (or more) unit may generate more than the level allocated to it in a static (i.e. classical) droop. As a result, compared to other units, it has less capacity available for reactive power contribution. Therefore, classical static reactive power sharing may increase switching stress on one unit's inverter while the others are making very small active and reactive power contribution. As discussed below, this approach will also increase the reactive power demand from an AG (which in turn reduces the system efficiency).

In resistive MGs, two main methods were identified in the literature: (1) it is shown in [10], [16]-[18] that in resistive lines, droops are active power-voltage and reactive power-frequency slopes. (2) References [18]-[20] proposed a method called “Virtual Impedance” to reduce the coupling between active and reactive power flow in low-voltage distribution network.

The role of virtual impedances in decoupling active and reactive power in a resistive microgrid has also been explored in previous arts for improving the overall output impedance of each DG system. For example, it was shown in [21], [22] that the virtual impedance approach (coupled with a synchronous reference frame phase-locked loop) can be used as a simple alternative for the autonomous sharing of output current of parallel DGs in a microgrid. This approach curbs the major drawbacks of droop-based control i.e. instability issues due to sudden load perturbation, poor transient response, inaccurate load sharing, steady state error of voltage and frequency [21]-[23]. The scheme in [21], [22] offers large stability margin and fast transient response; it also offers intrinsic control of harmonic components suitable for highly distorted load. However, the study did not take into account the generating capacity of the DG (i.e. the varying nature of renewable energy resources) in allocating the current sharing ratios among DGs.

Therefore, three different load sharing approaches in a resistive MG can be identified:
A. P-V, Q-f droop;
B. P-f, Q-V droop with virtual impedance; and,
C. Sharing based on the ratio of virtual impedances of units.

Similar to droop control in inductive MG, these approaches are insensitive to available generation capacity of renewable resource. For example, FIG. 2 shows a conventional virtual impedance (I-V) load sharing scheme where a voltage droop gain is determined irrespective of available energy. The DG's local voltage thus only changes due to load or line impedance change, which is constrained within the allowable voltage drop, in order to maintain the DG's local voltage within acceptable limits. In such cases, a drop in the available power of one of the DG from I1 to I1* (e.g. due to a reduction in solar irradiation) will shift its local voltage (V) to a new operating point (V*). Since the other DG must comply with the new operating voltage (V*), its power reduces from I2 to I2* (even though it might have the capacity to generate more power).

### Example Microgrid

An example microgrid (MG) 100 is shown in FIG. 3. The three classical load sharing approaches A, B and C referred to above will be discussed in detail with reference to the microgrid 100.

FIG. 3 shows an islanded MG 100 with two three-phase inverter-based DGs (DG1, 102 and DG2, 104) in a resistive (low voltage) network. A power electronic converter (PEC, 106) is used to control the flow of energy from a local fossil-fuelled AG 108 using local information from the DGs (specifically V_{DC1} and V_{DC2}). The present invention is concerned with the load sharing interaction between the DGs 102, 104 in a resistive, islanded MG network. The three-phase inverter-based sources are PWM controlled with classical cascaded voltage and current controllers.

### Classical Load Sharing in Resistive Microgrids

### A. P-V and Q-f Droop Load Sharing Scheme

In classical droop schemes, the active and reactive powers injected from the DG to the MG 100 are sensed and averaged; the resulting signals are used to adjust the frequency and voltage amplitude of the DG [7], [11], [14], [19].

In a resistive MG, the averaged active and reactive power (P and Q) of the DGs (deduced in [7]) is given in (1):

$$\begin{matrix}P = \frac{{V}^{2} - {VV}_{t} cos δ}{Z} \approx \frac{V}{R} ( V - {V}_{t} ) & ( 1 ) \\ Q = \frac{{VV}_{t}}{Z} sin δ \approx - \frac{{VV}_{t}}{R} δ & \end{matrix}$$

The droop block (defined by (1) and (2)) is used for proportional sharing of P and Q; where P varies with system voltage and Q with system frequency.

$$ω = {ω}_{ref} + {n}_{q} ( Q - {Q}_{ref} ) ; \\ {n}_{q} = \frac{Δ ω}{{Q}_{rated}} \\ V = {V}_{ref} - {m}_{p} ( P - {P}_{ref} ) ; \\ {m}_{q} = \frac{Δ V}{{P}_{rated}} \qquad ( 2 )$$

(V−Vₜ) is the voltage amplitude difference;
δ is the phase angle difference between the inverter output voltage (V) and the common AC bus voltage (Vₜ);
R is the output feeder resistance of the DG in the resistive network.
Δω and Δ∇ are the allowed frequency and voltage deviation.
mₚ and n_{q} are the droop coefficients (i.e. the gradient of droop lines, with reference to FIGS. 4a and 4b) which ensure the desired proportional power sharing based on the DG's rating (i.e. P_{rated} and Q_{rated}).

The droop slopes are strictly computed to ensure that accurate load sharing is possible without a significant steady state frequency and voltage deviation [14].

B. P-f and Q-V Droop with Virtual Impedance

The inductive-based P-f/Q-V droop scheme can also be used in a resistive network with the aid of a virtual impedance control loop. The droop equation can be re-written as:

$$ω = {ω}_{ref} - {m}_{p} ( P - {P}_{ref} ) ; \\ {m}_{p} = \frac{Δ ω}{{P}_{rated}} \\ V = {V}_{ref} - {n}_{p} ( Q - {Q}_{ref} ) ; \\ {n}_{q} = \frac{Δ V}{{Q}_{rated}} \qquad ( 3 )$$

Doing this, the PQ controller now uses the droop scheme (f vs P and V vs Q) to autonomously respond to changes in connected loads. In this scheme, proper design and selection of the virtual resistance and inductance is important for appropriate mitigation of the coupling between P and Q, and to enhance the reduction of circulating reactive current within the resistive network.

### C. Virtual Impedance Load Sharing Scheme

In inverter-based applications, the virtual impedance scheme provides an attractive way to shape the dynamic profile of the DG. This scheme can also be used for power flow control, and harmonic compensation. It also offers a fast control loop for fixing a stable phase and magnitude of the output impedance of the DG.

FIG. 5 shows an equivalent circuit of two parallel connected DGs with virtual impedances, where Vo1, Io1, Zo1, Zv1, and Zl1 are the output voltage, output current, output impedance, virtual impedance and line impedance respectively of DG1. Vo2, Io2, Zo2, Zv2, and Zl2 are the output voltage, output current, output impedance, virtual impedance and line impedance respectively of DG2, Vt is the terminal bus voltage of the MG.

The virtual impedance (shown in FIG. 5) is usually wired in series with the resistive line impedance to make the overall output impedance of the DG inductive, this in turn improves the stability and transient performance of the system. The virtual impedance scheme when implemented in a voltage control loop can also be used to autonomously promote current sharing between parallel-connected converters in a MG without the need for the classic droop controller.

The virtual impedance (Zᵥ) consists of virtual resistance (Rᵥ) and virtual (inductive) reactance (Xᵥ=ωLᵥ):

$${Z}_{v} = {R}_{v} + {jX}_{v} \\ {θ}_{v} = {tan}^{- 1} ( \frac{{X}_{v}}{{R}_{v}} ) \qquad ( 4 )$$

Writing KVL in αβ-frame for a unit shown in FIG. 5, and assuming that the virtual impedance is dominant, yields:

v_{oα}*=v_{α}*−R_{vα}i_{oα}−Xᵥi_{oβ})

v_{oβ}*=v_{β}*−R_{vβ}i_{oβ}−Xᵥi_{oα}) (5)

Xᵥ makes DG's output impedance more inductive, so that the decoupling between P and Q is vastly improved. In cases where droop load sharing scheme is employed, virtual impedance enhances the droop sharing characteristics (i.e. improved performance and stability). In addition to improving current sharing capability, Rv also limit voltage drop within small range. For an acceptable voltage regulation and proper load sharing characteristics, Rv is chosen to drop output voltage up to 2%-5% of the nominal voltage.

As discussed above, the prior art schemes did not consider the varying nature of renewable resources in active and reactive power sharing in MGs. Therefore, according to FIG. 2, if the available energy of one DG is not enough to meet the fixed demanded load imposed, a new operating voltage will be imposed which forces all other DGs on the network to its new operating point irrespective of the input solar power. In other words, a drop in generation of one unit causes reductions in all the other units' generation (see also the simulation results in FIG. 12b discussed below). This may lead to a shortage of supply which is compensated by the energy stored in the DC-links' capacitors (or a local energy storage) which causes a drop in the DC link voltage. Hence, the DC-link voltage (or the energy level of the energy storage) can be used to trigger an AG via a PEC to compensate for the shortage of energy. It is noted that since the other DGs are forced to reduce their generation, the energy demanded from the AG will not be optimized. This is due to the insensitivity of a static virtual impedance control scheme to the input solar energy (see FIG. 12 and associated description below).

### BRIEF DESCRIPTION OF THE EXEMPLARY EMBODIMENTS

The aim of the present invention is to make active and reactive power sharing sensitive to solar irradiation (without the need for measuring it), such that in an MG having a plurality of DGs, when power generation of one unit drops (for example due to a reduction in solar irradiation):
A. The other units do not drop their generation;
B. The other units increase their generation, provided that enough irradiation is available; and,
C. The units that generate less active power contribute more in reactive power, and vice versa.

According to a first aspect of the present invention there is provided a method of managing a microgrid comprising the steps of:
providing a microgrid comprising a plurality of renewable distributed generators, each renewable distributed generator having a respective inverter;
determining a variable related to the available power from each of a plurality of renewable distributed generators;
adjusting gains of each respective inverter according to a function of the variable from each renewable distributed generator.

The load sharing scheme may be any of:

A. P-V, Q-f droop scheme;
B. P-f, Q-V droop with virtual impedance scheme; and,
C. Sharing based on the ratio of virtual impedances of units.

Preferably the load sharing scheme is based on the ratio of virtual impedances of units (C above) and the gains (preferably the virtual resistance gains) are dynamically adjusted based on the variable.

In a preferred embodiment the step of adjusting gains comprises the step of adjusting the virtual resistance gains of each inverter according to a function of the variable from each respective renewable distributed generator.

According to a second aspect of the present invention there is provided a control system for a microgrid comprising:
a plurality of inverter controllers configured to each control an inverter for a renewable distributed generator;
in which each inverter controller is configured to adjust the droop gain of each respective inverter according to a function of a variable from each renewable distributed generator;
in which the variable is related to the available power from each of the plurality of renewable distributed generators.

The control system of the second aspect is configured to carry out the method of the first aspect.

According to a third aspect there is provided a software program, which when executed is configured to carry out the method according to the first aspect. The software may be provided on storage media for execution on a suitable processor.

The present invention thus proposes dynamic active and reactive power sharing in a resistive MG that reduces the active and reactive power demanded form a fossil-fuelled AG. The invention also reduces the switching stress on power electronic converters through allocating less reactive power contribution to those units that generate more active power, which in turn leads to less total harmonic distortion (THD) content (see FIG. 15 discussed below).

The present invention proposes a dynamic active and reactive power sharing; and investigates and compares its application on the above-mentioned approaches in a resistive MG. The proposed dynamic approach allows taking into account the rating, output impedance and voltage limits of each unit. The proposed dynamic scheme uses the PV array's current vs voltage characteristics in defining an operating range for the inverter-based source to ensure an efficient load sharing interaction with other DGs as the DC link voltages varies due to varying irradiance of solar energy. Dynamic reactive power (Q) sharing is also presented in order to maintain the apparent power rating S_{rated} of the DGs' inverters and to minimize Q demand from an AG. Moreover, unlike in the prior art, the control of an auxiliary generator (AG) to provide active and reactive power compensation in a low voltage MG is also presented.

Since the line is predominately resistive in a low-voltage MG (and Xᵥ is exploited to improve the decoupling between P and Q), Rᵥ is used for P and Q sharing. The present invention uses the direct component of the virtual resistance R_{vα} to regulated active current sharing; while the quadrature component of the virtual resistance R_{vβ} is chosen for reactive current sharing.

The invention provides that the output current interaction between N parallel-connected DGs is given below:

P₁R_{vα1}=P₂R_{vα2}= . . . =P_{N}R_{vαN}=ΔV

Q₁R_{vβ1}=Q₂R_{vβ2}= . . . =Q₂R_{vβN}=Δω (6)

Therefore, for a DG unit:

$${m}_{p α} = \frac{Δ V}{{P}_{rated}} \\ {n}_{q β} = \frac{Δ ω}{{Q}_{rated}} \qquad ( 7 )$$

where m_{pα} and n_{qβ} are proportional to R_{vα} and R_{vβ}, respectively. Equations (6) and (7) will proven in the specific description below.

### BRIEF DESCRIPTION OF THE DRAWINGS

An example control system and method according to the present invention will now be described with reference to the accompanying drawings in which:

FIG. 1 is a graph showing a classic P-f droop scheme;

FIG. 2 is a graph showing a static virtual impedance droop (V-P);

FIG. 3 is a schematic of a first microgrid network on which control according to the present invention may be implemented;

FIGS. 4a and 4b are graphs showing the classical active power-voltage, and reactive power-frequency droops in a resistive microgrid respectively;

FIG. 5 is an equivalent circuit of parallel-connected DGs with virtual impedance;

FIG. 6 depicts PV power vs PV voltage characteristic for different solar irradiations (G). The maximum power curve (B) is also shown;

FIG. 7 is a method to impose curve B (see FIG. 6) on droop/virtual impedance control scheme;

FIG. 8 is the characteristics of the active power-voltage and reactive power-frequency droops, based on the developed virtual impedance sharing scheme;

FIGS. 9a and 9b show a dynamic virtual impedance sharing scheme in a resistive MG according to the invention;

FIGS. 10a and 10b are active power-voltage and reactive power-frequency graphs showing dynamic droop operation for active and reactive power sharing;

FIG. 11 illustrates the calculation of reactive power that needs to be exchanged with the AG (i.e. Qerror) to protect the inverter's rating;

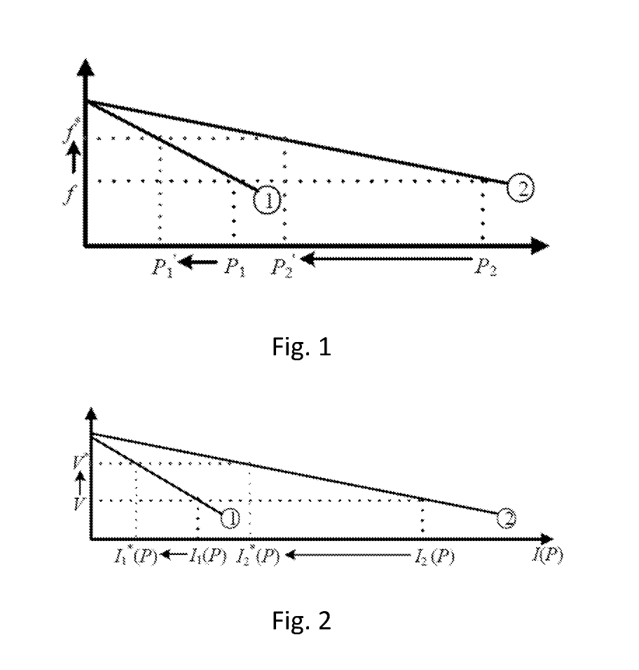

FIG. 12, graphs (a) to (f) show simulation results of two DG systems using static virtual impedance load sharing scheme for both Active and Reactive Power Sharing:
(a) available solar power in pu;
(b) static scheme: active power in pu (note that P₂ reduction reduces P₁);
(c) output voltage in pu;
(d) available capacity for reactive power in pu;
(e) Static scheme: reactive power in pu;
(f) Frequency in pu;

FIG. 13, graphs (a) to (f) show simulation results of two DG systems using virtual impedance load sharing scheme showing dynamic Active power and static Reactive Power Sharing:
(a) available solar power in pu;
(b) Dynamic scheme: active power in pu (note that P₁ increases to compensate for P₂ reductions, hence, P_{ag} remain zero);
(c) output voltage in pu;
(d) available capacity for reactive power in pu;
(e) Static scheme: reactive power in pu (note that unit 1 generate more active and reactive power than unit 2; while from 10 sec onward Qₐᵥₐᵢₗ₂>Qₐᵥₐᵢₗ₁);
(f) Frequency, pu;

FIG. 14, graphs (a) to (f) show simulation results of two DG systems using the proposed dynamic virtual impedance load sharing scheme for both dynamic Active and Reactive Power Sharing:
(a) available solar power in pu;
(b) Dynamic scheme: active power in pu (note that P₁ increases to compensate for P₂ reductions, hence, P_{ag} remain zero);
(c) output voltage in pu;
(d) available capacity for reactive power in pu;
(e) Dynamic scheme: reactive power in pu (note that as P_{I} increases, Q₁ reduces; and as P₂ reduces, Q₂ increases);
(f) Frequency, pu;

FIG. 15, Bar charts illustrating the output voltage's Total Harmonic Distortion (THD) for the three testing scenarios:
(a) Static P and static Q sharing
(b) Dynamic P and static Q sharing
(c) Dynamic P and dynamic Q sharing (note the significant reduction in THD); and,

FIG. 16, graphs (a) to (c) show simulation results of two DG systems using the real-time solar data
(a) Available solar power in pu;
(b) AG Energy profiles in pu;
(c) AG Reactive Energy profiles in pu.

### DETAILED DESCRIPTION

The mathematical model of a PV array is described in [28] with P-V characteristic shown in FIG. 6. It was also shown in [6] and [29] that a three-phase inverter (with sinusoidal PWM) can averagely be modelled using α-β frame transformation techniques:

|V_{αβ}|≈½|m_{αβ}|V_{DC} (8)

where V_{αβ} is the α-β frame Clarke transform of the DG voltage, |mαβ| is the modulating index (in α-β frame) and V_{DC} is the DC link voltage.

Generally V_{DC} perturbs in response to irradiance level and demanded load; when there is a reduction in solar irradiance level (hence decreasing V_{DC}), m must increase to maintain (according to (8)). At m=1; a constant |V_{αβ}| depends solely on V_{DC}. Further reduction in V_{DC} due to irradiance reduction will reduce |V_{αβ}| d. Hence, in order to accurately control AC bus voltage (|V_{αβ}| d), minimum DC voltage V_{DC-min} must ensure (8) while m=1; E.g. for a nominal RMS 230V DGs system explained in [17], VDC≥650.54V (i.e. operating point limit with modulating index, m=1). Thus, the PV array must be designed such that the DC voltage of the maximum power at a small irradiation (say 0.05 pu)=V_{DC-min}=650.54V (see FIG. 6).

In the absence of maximum power tracking, the PV operating point is usually determined by the AC-side load demand; hence the DC link voltage (V_{DC}) will be perturbed continuously from the minimum operating voltage (V_{DC-min}) to the PV array's open circuit voltage (V_{OC}) as the irradiance level or load varies (FIG. 6). The proposed dynamic droop scheme uses the variation in irradiance (i.e. V_{DC}) in conditioning the conventional static sharing schemes for an efficient load sharing. This will involve a linear approximation of the PV maximum power point characteristic curve (B in FIG. 6) and the subsequent droop gain tracking the irradiance variation within the DG's operating zone. When available solar power is more than the load power, the system operates normally within its operating zone (right hand side of curve B in FIG. 6). As solar irradiation (G) drops, the DG will continue to supply the load, until the available solar power is not enough to meet the demand (point O); AG is thus triggered on (when V_{DC} becomes less than a threshold) to compensate for the shortage in energy.

In order to make sure that when the input solar power of one unit drops; the other units do not follow it, the sharing scheme must be sensitive to the input power. However, since measuring solar irradiance is not practical, the present invention makes the sharing scheme vary according to the maximum power curve (i.e. curve B in FIG. 6), which can be linearized as [17], [30]:

P_{DC-max-n}=kₙV_{DC-opt-n}+cₙ (9)

Where:
kₙ and cₙ are gains to get a linear approximation of the maximum power curve of the nth PV array.
V_{DC-opt-n} is the DC link voltage of the nth PV array when the PV power is maximum (i.e. curve B in FIG. 6).

Since the PV power Pₚv is intermittent, the maximum reactive power, Qₐᵥₐᵢₗ that can be exchanged by the inverter is varying as given in [6]:

Qₐᵥₐᵢₗ=\sqrt{S_{rated}²−Pₚᵥ²} (10)

In (10), Qₐᵥₐᵢₗ increases for reduction in solar irradiance (G) of a DG unit.

For a given load (P_{Load}) and a given solar irradiation (G₁) shown in FIG. 6, the steady state operating point can be, theoretically, anywhere on line OC (AG will be needed on left side of O). However, only point O is located on the maximum power curve B. Therefore, if any point but O is chosen as the steady state operating point, maximum power point tracking will not be possible when it is needed (e.g. when solar irradiation of other unit(s) drops). Hence, an optimized sharing scheme must have the following characteristics:
1. All units must operate on curve B (FIG. 6); and,
2. Units with higher P contributions must have lower Q contributions since Qₐᵥₐᵢₗ reduces as Pₚᵥ increases.

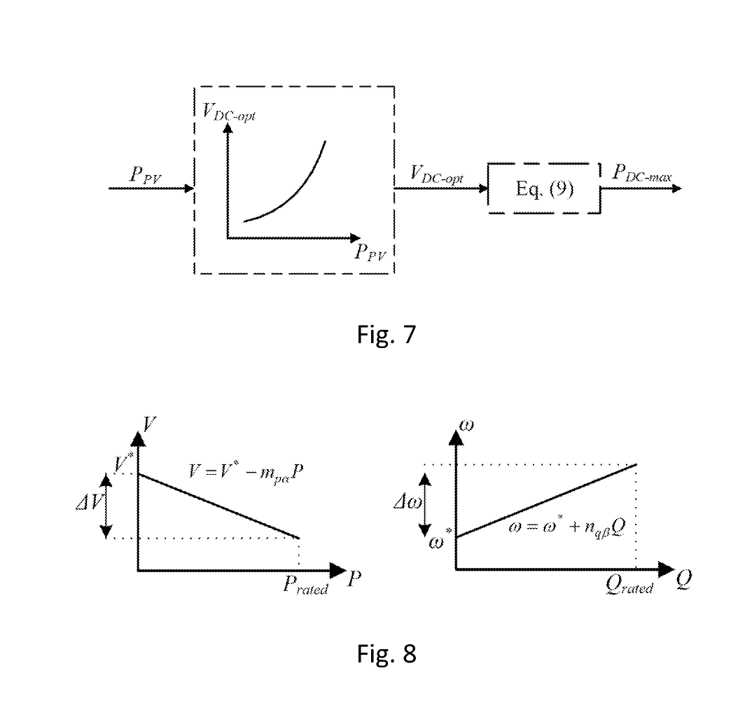

In order to impose the operation on curve B, FIG. 7 is proposed. In FIG. 7, the measured PV power Pₚᵥ is passed through Pₚᵥ-V_{DC-opt} curve explained in [30], to get V_{DC-opt} which is used in (9) to get P_{DC-max}. Using FIG. 7 will create a closed loop which makes Pₚᵥ=P_{DC-max} at steady state. P_{DC-max} will be used for sharing active power and Qₐᵥₐᵢₗ will be used for sharing reactive power (explained below). At steady state Pₚᵥ=P_{DC-max}, i.e. the method also ensures that the maximum power from each unit is generated if required by the load, while taking into account the rating, output impedance (in virtual impedance approach) and voltage limits of each unit.

The present invention is primarily concerned with the application of FIG. 7, (9) and (10) in the dynamic virtual impedance load sharing scheme, as will be discussed below. That said, the present invention can be employed in all three known schemes for the dynamic active and reactive power sharing in a resistive MG as follows:

### A. Dynamic P-V and Q-f Droop

Dynamically, (2) is now set based on (9) and (10) as follows:

$${n}_{q} = \frac{Δ ω}{{Q}_{avail}} ; {m}_{q} = \frac{Δ V}{{P}_{DC \text{-} max}} \qquad ( 11 )$$

For instance, if solar irradiation of one unit drops, its V_{DC-opt} and P_{DC-max} drops causes reduction in P contribution through increasing its mₚ. Reduction in Pₚᵥ=P_{DC-max} causes increase in Qₐᵥₐᵢₗ which in turn increases Q contribution through reducing n_{q}. Moreover, other units can compensate for P reduction (assuming there is enough G)

B. Dynamic P-f and Q-V Droop with Virtual Impedance

Similarly, in the presence of virtual impedance scheme, (3) can be re-written as:

$${n}_{q} = \frac{Δ ω}{{Q}_{avail}} ; {m}_{p} = \frac{Δ ω}{{P}_{DC \text{-} max}} \qquad ( 12 )$$

The droop mechanism in (11) and (12) are now sensitive to the available solar power. It should be noted that the droop gains are still proportional to the ratings of their associated units.

### C. Dynamic Virtual Impedance Load Sharing Scheme

Eq. (5) explained the KVL of an inverter voltage and current in αβ frame. As explained above, Xᵥ is used to decouple active and reactive powers through increasing the inductive characteristics of the total output impedance. Therefore, we can use R_{vα} and R_{vβ} to control active power (voltage) and reactive power (frequency), respectively, as discussed below:

Since at steady state the voltage drop due to X, is negligible, (5) can be written as:

v_{oα}=v_{α}*−R_{vα}i_{oα}→Δv_{α}=R_{vα}i_{oα}

v_{oβ}=v_{β}*−R_{vβ}i_{oβ}→Δv_{β}=R_{vβ}i_{oβ} (13)

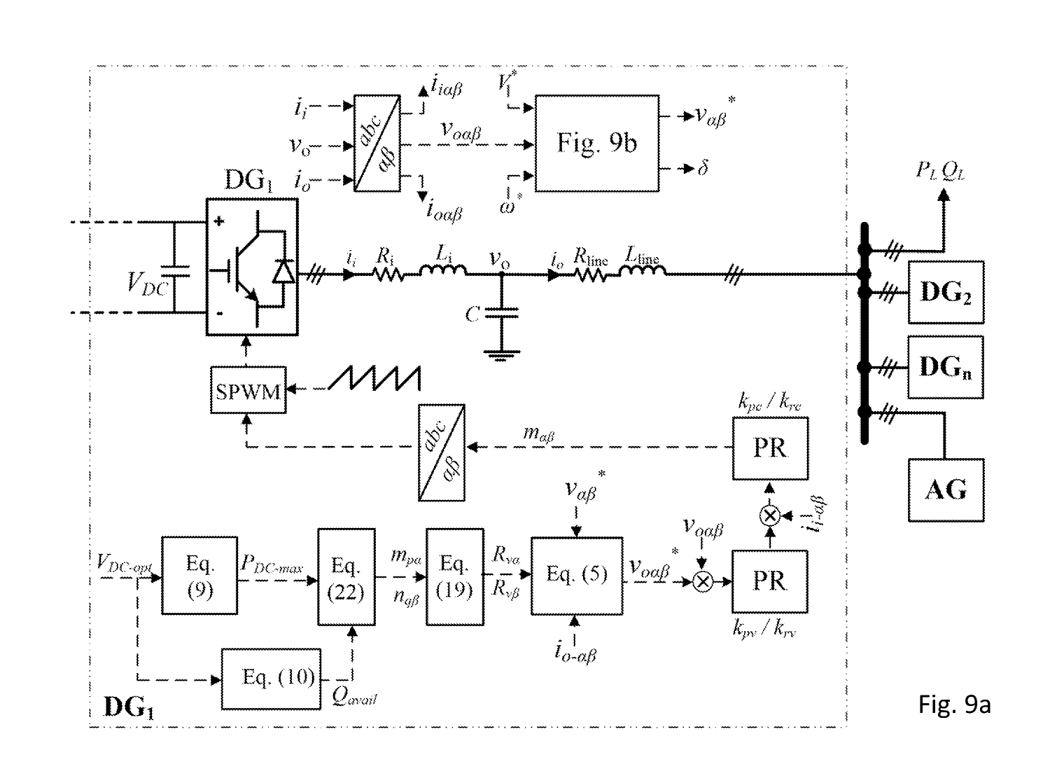

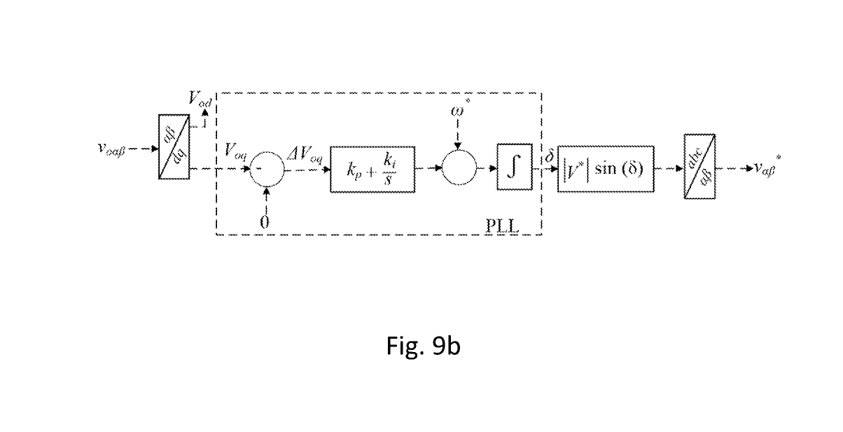

As shown in FIG. 9.b, PLL makes V_{q}=0 at steady state, hence using Park Transform:

$${v}_{a α} = {V}_{od} cos δ - {V}_{oq} sin δ {\to }^{ {PLLV}_{q} = 0 } {v}_{o α} = {V}_{od} cos δ \\ {v}_{a β} = {V}_{od} sin δ + {V}_{oq} cos δ {\to }^{ {PLLV}_{q} = 0 } {v}_{o β} = {V}_{od} sin δ \qquad ( 14 )$$

Since using Xᵥ the total output impedance is mainly inductive, δ is relatively small. Thus at steady state, (cos δ)→1 and (sin δ)→δ≈0, which simplifies (14) as:

$${v}_{a α} = {V}_{od} cos δ {\to }^{ δ \to 0 } \vert {v}_{o α} \vert \to {V}_{od} \\ {v}_{a β} = {V}_{od} sin δ {\to }^{ δ \to 0 } \vert {v}_{o β} \vert \to {V}_{od} δ \qquad ( 15 )$$

Therefore, the active and reactive powers in αβ frame are:

$$P = 1.5 ( {v}_{o α} {i}_{o α} + {v}_{o β} {i}_{o β} ) {\to }^{\vert {v}_{o β} \vert \to 0 and \vert {v}_{o α} \vert \to {V}_{od } } P = 1.5 ( {V}_{od} {i}_{o α} ) \\ Q = 1.5 ( {v}_{o β} {i}_{o α} - {v}_{o α} {i}_{o β} ) {\to }^{\vert {v}_{o β} \vert \to 0 and \vert {v}_{o α} \vert \to {V}_{od } } Q = - 1.5 ( {V}_{od} {i}_{o β} ) \qquad ( 16 )$$

Equations (16) shows that active power can be controlled by i_{oα}, and reactive power can be controlled by i_{oβ}. Moreover, substituting (15) into (13), gives:

ΔV_{od}=R_{v-α}i_{oα}

V_{od}Δδ=R_{v-β}i_{oβ} (17)

Calculating i_{oα} and i_{oβ} from (16), and substituting them into (17) gives:

(1.5V_{od})ΔV_{od}=R_{vα}P

(1.5V_{od}²)Δδ=−R_{vβ}Q (18)

Through using (18), taking into account that ω=∫δdt, and V_{od}≈V*=1 pu (at steady state), one can derive the droop equations based on virtual resistance as (19):

$$V = {V}^{*} - {m}_{p α} P , {m}_{p α} = \frac{{R}_{v α}}{1.5 {V}^{*}} \\ ω = {ω}^{*} + {n}_{q β} Q , {n}_{q β} = \frac{{R}_{v β}}{1.5 {( {V}^{*} )}^{2}} \qquad ( 19 )$$

Equation (19) is depicted in FIG. 8.

For a system consisting of N parallel-connected DG, (20) can be written (which is the same as (6) but using m_{pα} and n_{qβ}):

P₁m_{pα1}=P₂m_{pα2}= . . . =P_{N}m_{pαN}=ΔV

Q₁n_{qβ1}=Q₂n_{qβ2}= . . . =Q₂n_{qβN}=Δω (20)

where, ΔV and Δω are the allowed voltage and frequency deviations. Using the proposed virtual resistance sharing in a conventional static droop:

$${m}_{p α} = \frac{Δ V}{{P}_{rated}} and {n}_{q β} = \frac{Δ ω}{{Q}_{rated}} \qquad ( 21 )$$

Combining the proposed dynamic droop with the proposed virtual resistance droop yields:

$${m}_{p α} = \frac{Δ V}{{P}_{DC \text{-} max}} and {n}_{q β} = \frac{Δ ω}{{Q}_{avail}} \qquad ( 22 )$$

Since P and Q are perfectly decoupled through using Xᵥ, a reduction in solar irradiation of one unit increases R_{vα} (through increasing m_{pα}), which in turn reduces P (according (20)). The reduction in P increases Qₐᵥₐᵢₗ, which reduces R_{vβ} (through reducing n_{qβ}), which in turn increases Q (according to (20)). Since other units also are controlled using the proposed dynamic virtual impedance (i.e. (22)), they will adjust their P and Q accordingly to supply the load and to comply with the voltage and frequency standards.

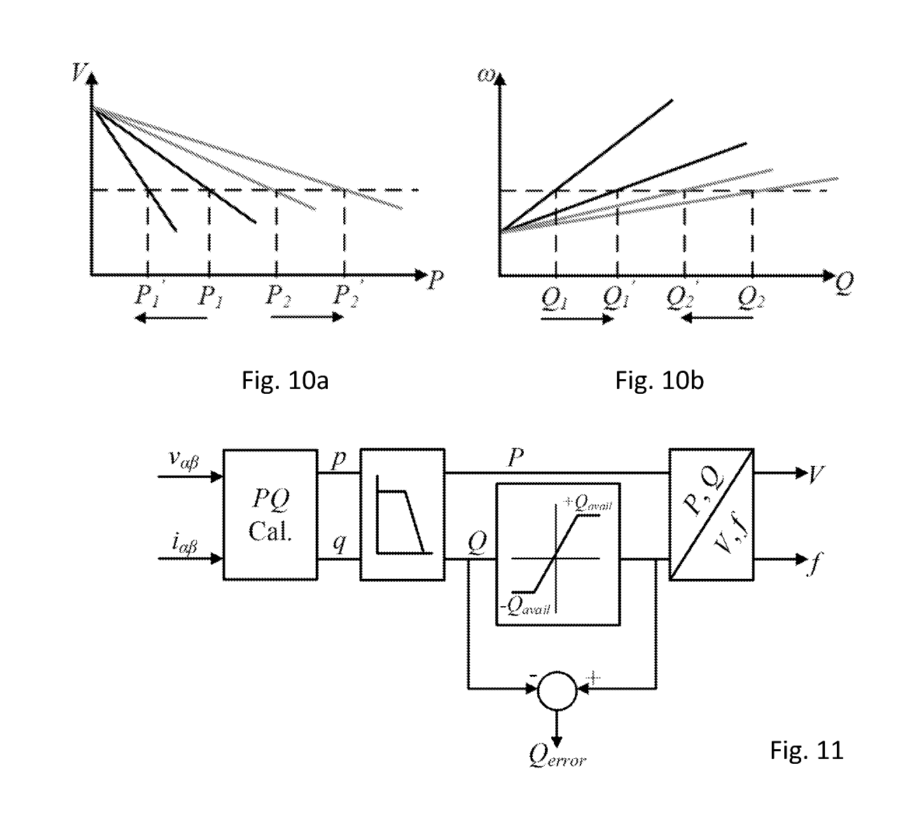

The available reactive power (Qₐᵥₐᵢₗ) of a DG unit increases with decreasing available irradiation according to (10). In the case of static virtual impedance scheme, a fixed Q-droop gain is set irrespective of Qₐᵥₐᵢₗ, hence DG unit are not fully optimized for Q_{Load} sharing leading to excessive switching stress on the inverter. However using the proposed scheme, as shown in FIG. 10a&b, a reduction in P₁ to P₁′, causes P₂ to increase (assuming enough G). Hence, Qₐᵥₐᵢₗ₁ increases and Qₐᵥₐᵢₐₗ₂ reduces which according to (22) and (20) increases Q₁ and reduces Q₂ (see results in FIG. 14). By adopting the proposed approach, significant reduction in the energy demanded from AG is achieved when compared to conventional static scheme (see FIG. 16 for results).

In a resistive MG, P-V, Q-f droops approach (i.e. section A above) is the simplest, however, has the disadvantage of relatively unstable operation in comparison with the virtual impedance scheme that improves the system stability [21, 22, 25]. Having both droop (P-f & Q-V) and virtual impedance schemes (i.e. section B above), although possible, seems redundant as only virtual impedance scheme can be used for load sharing. Therefore, the preferably embodiment of the present invention as discussed in the following description and the simulation results mainly concentrate on the virtual impedance approach (i.e. section C above); however, a comparison of all three approaches in terms of active and reactive power demanded from AG is also presented (FIG. 16).

FIGS. 9a and 9b illustrate the proposed dynamic virtual impedance sharing scheme in a resistive MG. The control paradigm is based on the classical cascaded voltage and current control using proportional resonant (PR) controller [21]. Stationary reference frame parameters were generated using Clarke transforms as implemented in [22]. In FIGS. 9a and 9b, the virtual impedance load sharing scheme uses the droop scheme (V vs I) to autonomously respond to changes in connected loads, while a PLL ensures internal frequency synchronization, in order to ensure accurate regulation of P and Q [31, 32].

### Auxiliary Generator Control

### (i) P Control

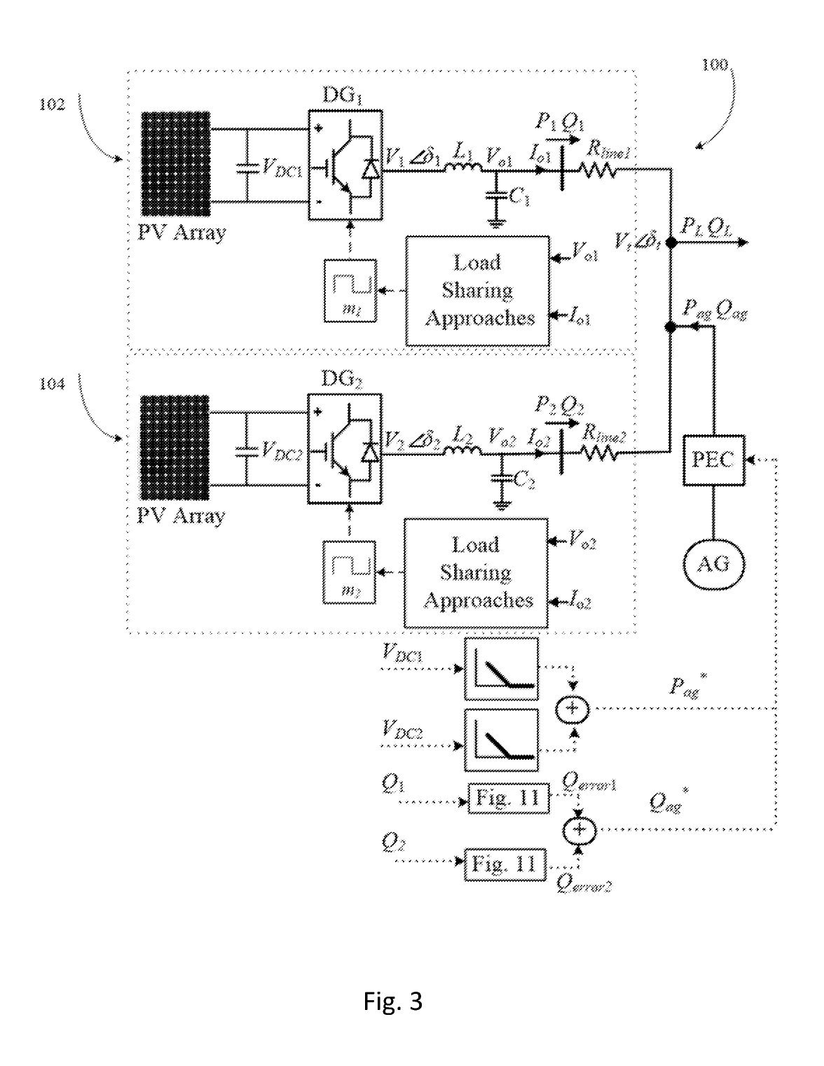

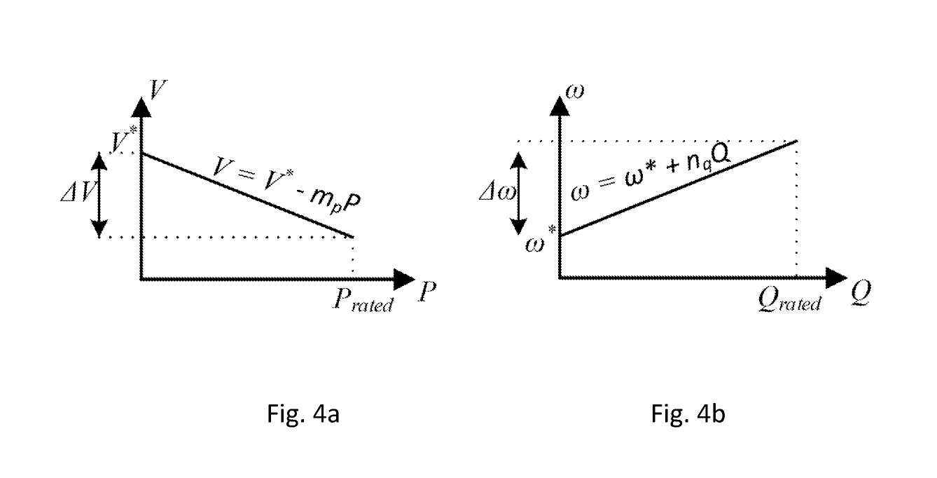

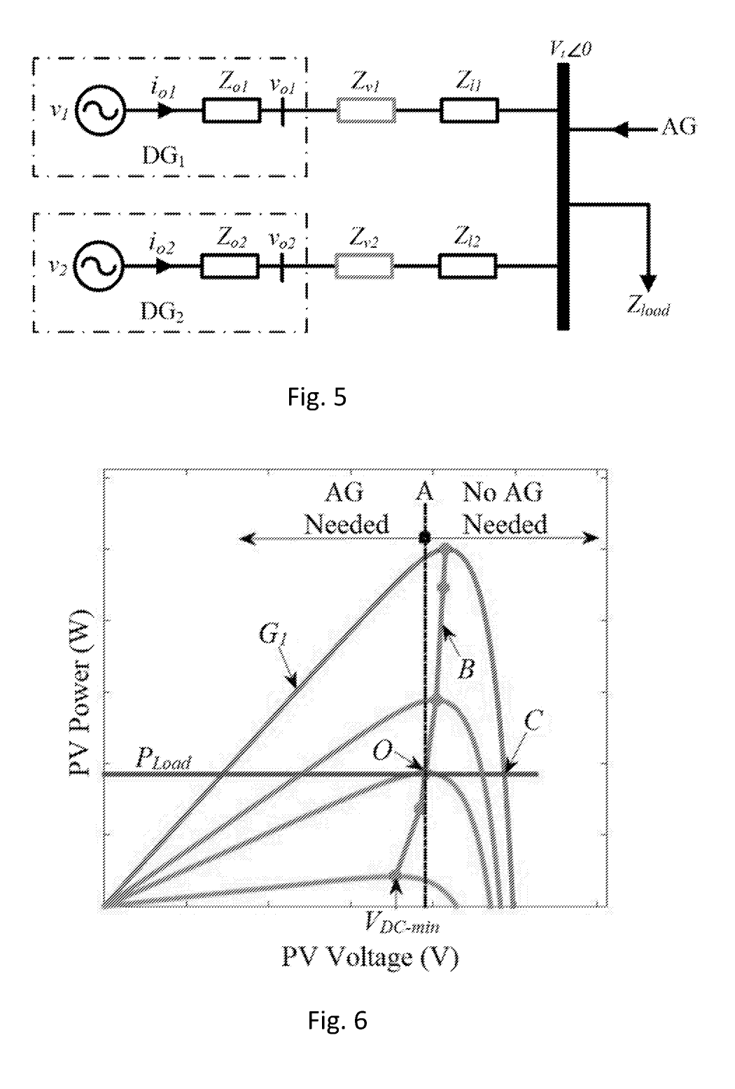

The DC link voltage is used as indicator for regulating the AG (see FIG. 3) to provide active power compensation. When the DC link voltage of either DGs decreases below a threshold (here DC threshold=0.85pu, AG is switched ON to compensate for the energy shortage. The AG reference active power (FIG. 9a) is:

$${P}_{aux}^{*} = - 3 {\sum }_{n = 1}^{N} {V}_{DC \text{-} n} \qquad ( 23 )$$

### (ii) Q Control

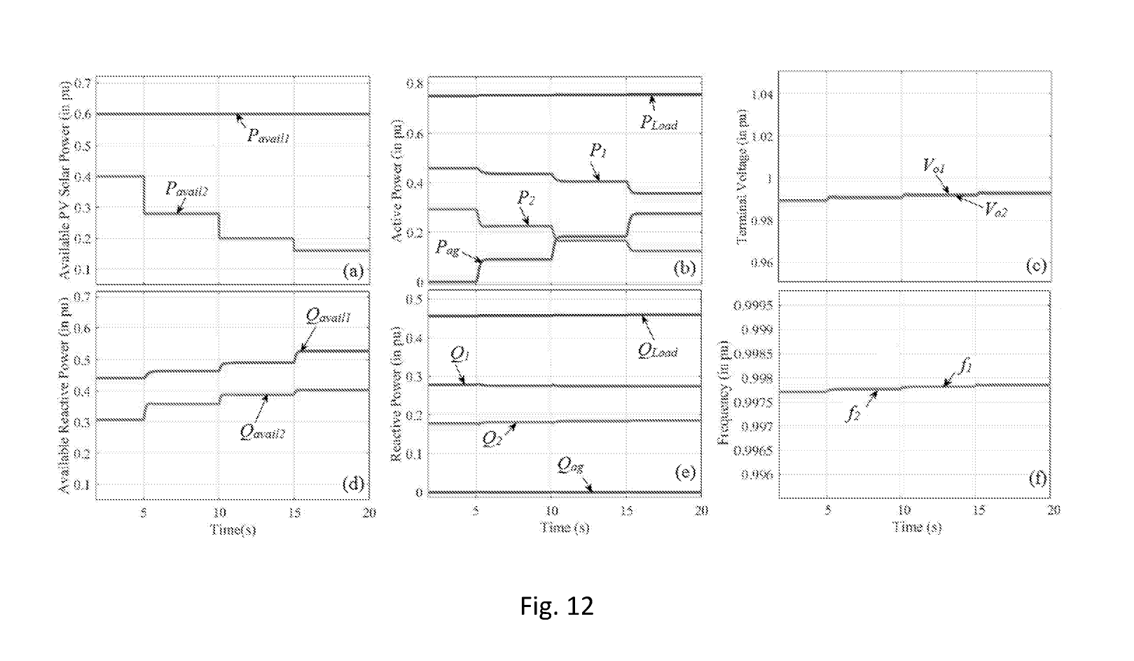

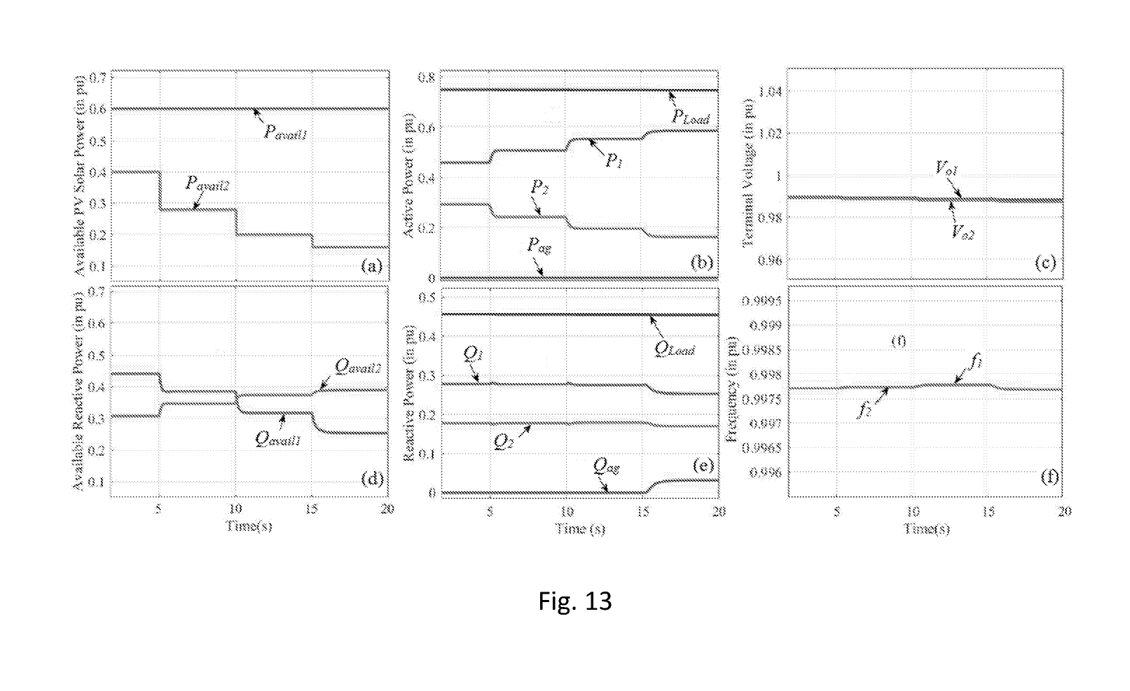

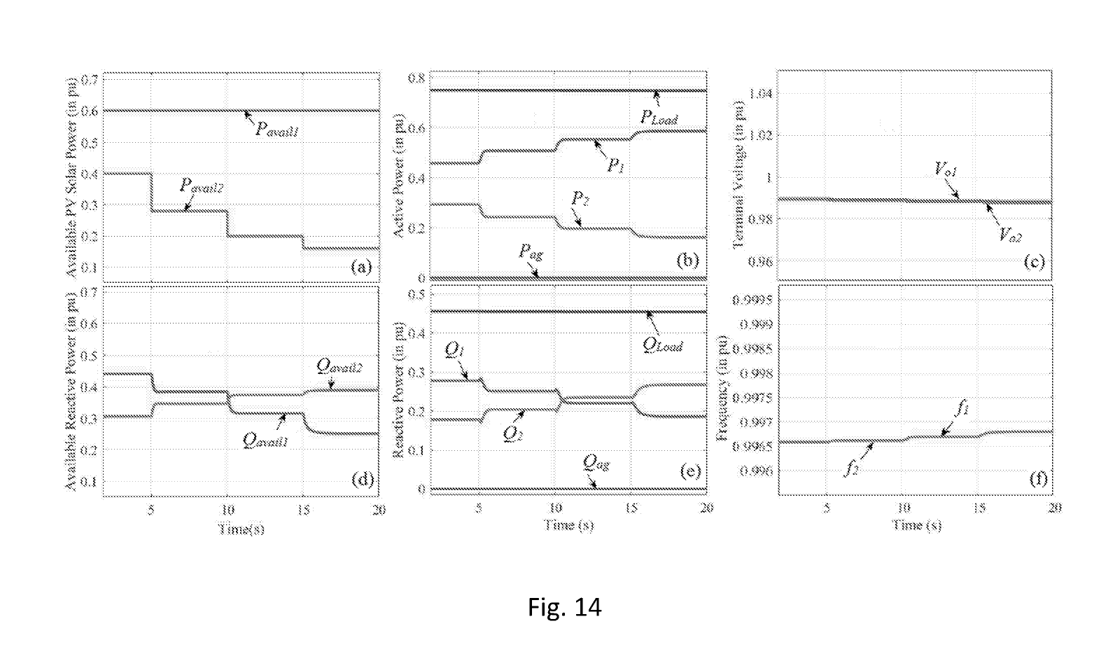

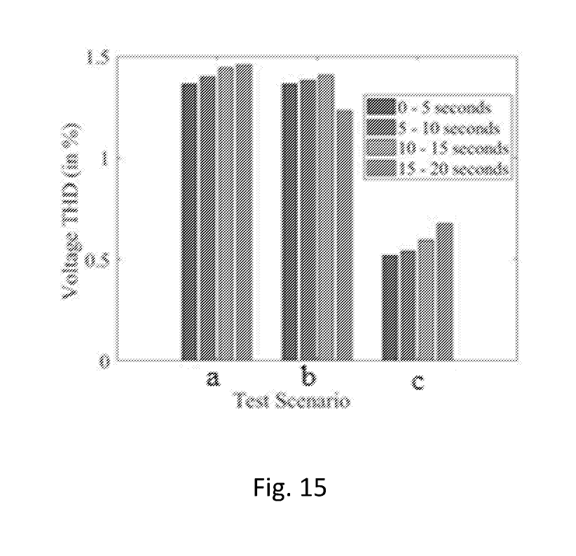

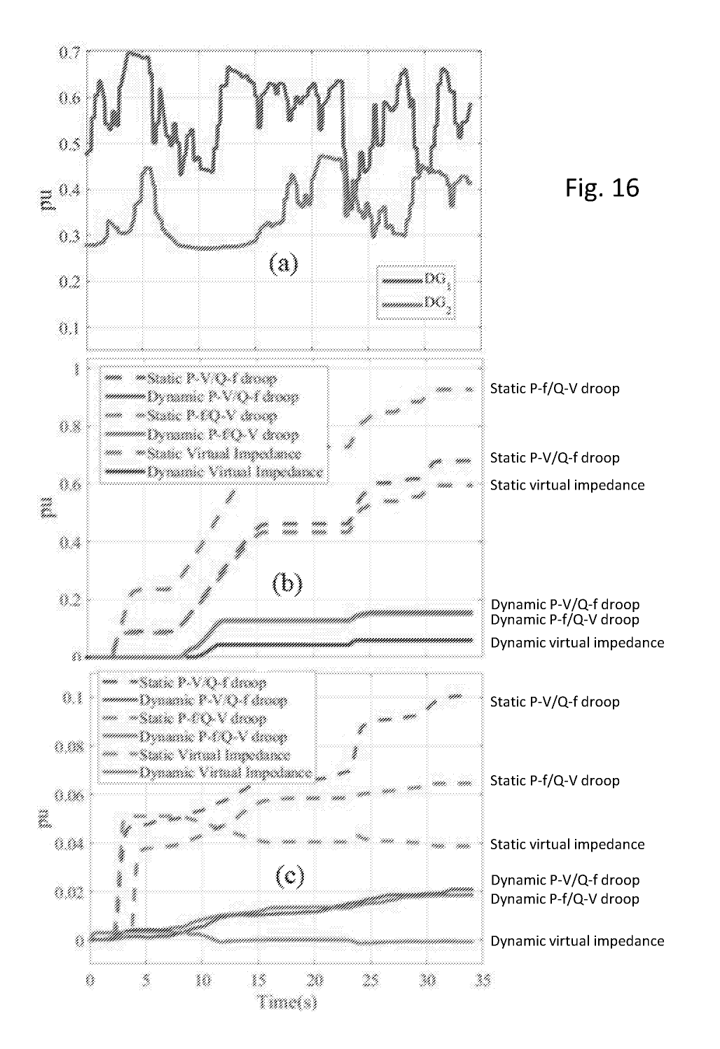

The local reactive power difference of DGs is used as indicator for regulating the AG (see FIG. 11) to provide reactive power compensation. When local reactive power of either DG increases above the available reactive power (i.e. Q≥Qₐᵥₐᵢₗ), AG is switched ON to provide reactive power compensation. The AG's reference reactive power (FIG. 9a) is:

$${Q}_{aux}^{*} = - 5 {\sum }_{n = 1}^{N} {Q}_{error \text{-} n} \qquad ( 24 )$$

The proposed method exploits the available capacity of the PV inverter to support the local voltage without violating either the S_{rated} of the inverter or its voltage limitations [6].

Thus the PQ control scheme in [33] and [34] was adopted in the AG control for injecting active power and reactive power into the network when needed, where references P and Q are set by (23) and (24).

### VI. Simulation Results

The MG 100 shown in FIG. 3, with parameters explained in Table I, was simulated using Matlab-SIMULINK.

TABLE I

| Variable | Value | | Variable | Value | |
|---|---|---|---|---|---|
| V_{L-L} | 415 | V | f* | 50 | Hz |
| S_{rated1}/S_{rated2} | 0.6/0.4 | (pu) | S_{Load} | 0.875 | (pu) |
| P_{Load}/Q_{Load} | 0.75/0.45 | (pu) | Rₗᵢₙₑ/Xₗᵢₙₑ | 7.7 | |
| LC filter | 4 mH/16 μF | | kₚᵥ/kᵢᵥ | 0.09/86 | |
| k₁ and c₁ (Eq. 9) | 76.48 and −50692.01 | | k_{pc}/k_{ic} | 0.05/0 | |
| k₂ and c₂ (Eq. 9) | 43.05 and −28442.60 | | kₚ₋ₚₗₗ/kᵢ₋ₚₗₗ | 1.2/1200 | |
| Length of line | 0.5 | km | C₀ | 1200 | (μF) |

The test model consists of two DGs and one AG feeding a three-phase load (demanding both active and reactive power). Each DG has its own control scheme (including virtual impedance loop) and the load sharing scheme is simulated for both conventional and dynamic virtual impedance scheme. The rating of each inverter-based source, S_{rated} should not be violated. Here S_{rated1}=S_{rated2}=1.05 puₚᵥ (puₚᵥ denotes pu based on the rating of the associated PV array). The simulation is tested for fixed active power load demand (P_{L}) and reactive load demand (Q_{L}) in the presence of variable solar irradiation.

### A. Load Sharing Scheme in Resistive Network Using Virtual Impedance Scheme.

The conventional virtual impedance load sharing scheme was tested for two PV DG sources shown in FIG. 3 in a resistive network, to observe the load sharing interaction feeding both active and reactive load demand. The load sharing was observed between the DGs where solar irradiation of DG2 drops in steps and the load active/reactive power are fixed at 0.75/0.45pu.

Different load sharing scenarios were simulated in MATLAB/SIMULINK: static-P/static-Q sharing, dynamic-P/static-Q, and dynamic-P/dynamic-Q for the network depicted in FIG. 3. Note that all results are presented in pu based on the total system rating (not each PV system).

i. Static P and Static Q (FIG. 12)

The network in FIG. 3 was simulated using conventional static virtual impedance i.e. (21). FIG. 12 shows accurate load sharing between the two DGs, which shows the effectiveness of the virtual impedance load sharing scheme.

Up to 5s, the load is appropriately shared based on their rating since the available solar power (Pₐᵥₐᵢₗ₁ and Pₐᵥₐᵢₗ₂ in FIG. 12.a) on both systems is the same (i.e. 1puₚᵥ).

At 5s, as the available power in DG2 (FIG. 12.a) drops due to drops in irradiance level, its local voltage changes to a new operating point resulting in a reduction in power contribution to the load (FIG. 12.b). DG1 complies with this new operating point and reduces its power contribution (FIG. 12.b) although its solar irradiance is constant (FIG. 12.a). As a result, the total generation becomes less than the load which leads to reduction in V_{DC}. When V_{DC}<0.85 pu, the AG is triggered on to supply the shortage. It is important to note that over the entire simulation the total available solar power (Pₐᵥₐᵢₗ₁+Pₐᵥₐᵢₗ₂)>P_{Load} i.e. there should not be any need for AG.

The available reactive power is shown in FIG. 12.d, it is noted that Qₐᵥₐᵢₗ₁ and Qₐᵥₐᵢₗ₂ increase as P1 and P2 decrease, however, due to the fixed sharing ratio, the shared reactive power (based on the fixed sharing ratio) from DG1 and DG2 remain constant for the entire simulation time (FIG. 12.e).

ii. Dynamic P and Static Q (FIG. 13)

The simulation of the virtual impedance scheme in FIG. 3 was repeated with m_{pα} (i.e. P) varies according to (22) while n_{pβ} (i.e. Q) remain constant according to (21). The results in FIG. 13.b shows that the power is shared based on rating when the solar irradiances are the same (up to 5s).

At 5s, as the available power on DG2 reduces, its m_{pα} increases which in turn reduces the power contribution of DG2 to the overall load. However, the m_{pα} of DG1 proportionally reduces to compensate for the power drop in DG2 (since DG1 has extra capacity to compensate for DG2). Due to DG1 compensation for DG2, the AG power P_{ag}=0, as shown in FIG. 13.b.

FIG. 13.d shows Q_{available} for DG1 and DG2. It is noted that Qₐᵥₐᵢₗ₁ drops as P₁ increases while Qₐᵥₐᵢₗ₂ increases as P₂ drops. However, due to fixed nₚp (as shown in FIGS. 13.e), Q₁ and Q₂ remain constant (until 15s) regardless of their Q_{available}. At 15s, Q_{DG1}>Qₐᵥₐᵢₗ₁; hence according to FIG. 11, AG is triggered ON to compensate for the deficiency in reactive power supply (FIG. 13.e). It is noted that although Qₐᵥₐᵢₗ₂ increases, Q₂ remains constant which demonstrates an inefficient Q sharing.

iii. Dynamic P and Dynamic Q (FIG. 14)

The simulation was repeated while both m_{pα} and n_{pβ} vary according to (22), using the proposed method according to the invention illustrated in FIG. 9a.

FIG. 14.b shows that P is dynamically shared appropriately based on available generation. In addition, as shown in FIG. 14.e, reactive powers are now dynamically regulated so that contributed reactive power changes proportional to Q_{available} variations: increase in P₁ to compensate drop in P₂ will result in reduction in Qₐᵥₐᵢₗ₁; hence the dynamic droop conditions a reduction in Q₁ and an equivalent increase in Q₂ (since Qₐᵥₐᵢₗ₂ increases as P₂ drops). As a result, the switching stress on each DG's converter is reduced since unit with more P generation has less Q contribution to the load. As it can be seen from FIG. 15, where the THD of the output voltage of the three test scenarios are compared, the THD of case c (i.e. dynamic P and dynamic Q) is much less than the other schemes.

B. Simulation Results with Real-Time Solar Irradiance Variation (FIG. 16)

The low-voltage network was also tested using real-time (measured) solar irradiation profile (shown in FIG. 16.a) for droop and virtual impedance load sharing scheme. FIG. 16.b shows the energy demand from the AG using different sharing schemes. Energy saving is calculated and shown in Table II by comparing the energy demand of each sharing scheme to the energy demand in static P-f/Q-V droop scheme (this serve as the reference).

TABLE II

| | Energy Demand | Energy Saved |
|---|---|---|
| Loading Scheme | (%) | (%) |
| Static P-V/Q-f | 67.94 | 24.68 |
| Dynamic P-V/Q-f | 15.62 | 77.00 |
| Static P-f/Q-V | 92.62 | 0.00 |
| Dynamic P-f/Q-V | 15.04 | 77.58 |
| Static virtual impedance. | 59.47 | 33.15 |
| Dynamic virtual impedance. | 5.87 | 86.75 |

FIG. 16.b shows that the dynamic virtual impedance sharing scheme provides more energy saving (up to 87% for the data set studied) from the AG when compared with other load sharing schemes.

A quantity, similar to energy, is also required to compare the reactive power from the AG for various sharing schemes. “Reactive Energy” is thus introduced; which is the integral of the AG's reactive power. As shown in FIG. 16.c, the dynamic virtual impedance sharing scheme required the minimum “reactive energy” from the AG.

Variations fall within the scope of the present invention. Although the above embodiment discusses varying the virtual resistance in the αβ reference frame, it will be noted that the same system can be applied in the DQ frame.

The above results utilise closed-loop control of the AG such that P_{ag} and Q_{ag} track P*_{ag} and Q*_{ag} accurately. It will be understood that feed-forward control could less preferably be used.

The proposed dynamic active and reactive power sharing method was validated using MATLAB/SIMULINK. Three different sharing schemes for resistive microgrid were outlined, and the application of the proposed dynamic sharing method on them was expressed. Simulation results show that the proposed dynamic virtual impedance provides more energy saving in comparison with the other load sharing approaches. The proposed scheme was validated for multiple PV array with various irradiance conditions; and it was shown that power sharing is proportional to the units' ratings when the irradiance levels are the same. However, if the solar available power on one PV array drops, the other units can generate more power (if the capacity is available) to compensate for the drop, without the need for energy support from local auxiliary generators and thereby providing significant energy saving compared with conventional static droop control techniques. In addition, switching stresses on the inverter-based sources are vastly reduced by dynamically regulating the reactive power demand, through reducing the reactive power contribution of units with higher active power contribution. It was shown that the dynamic reactive power contribution also reduces the demanded reactive power from a local auxiliary generator. The scheme was also validated with real-time (measured) solar irradiation.

### REFERENCES

[1] H. Mahmood, D. Michaelson, and J. Jin, “A Power Management Strategy for PV/Battery Hybrid Systems in Islanded Microgrids,” IEEE Emerging and Selected Topics in Power Electron., vol. 2, pp. 870-882, October 2014.
[2] K. T. Tan, X. Y. Peng, P. L. So, Y. C. Chu, and M. Z. Q. Chen, “Centralized Control for Parallel Operation of Distributed Generation Inverters in Microgrids,” IEEE Trans. Smart Grid, vol. 3, pp. 1977-1987, December 2012.
[3] K. Jong-Yul, J. Jin-Hong, K. Seul-Ki, C. Changhee, P. Jine-Ho, K. Hak-Man, and N. Kee-Young, “Cooperative Control Strategy of Energy Storage System and Microsources for Stabilizing the Microgrid during Islanded Operation,” IEEE Trans. Power Electronics, vol. 25, pp. 3037-3048, December 2010.
[4] L. Yun Wei and K. Ching-Nan, “An Accurate Power Control Strategy for Power-Electronics-Interfaced Distributed Generation Units Operating in a Low-Voltage Multibus Microgrid,” IEEE Trans. on Power Electronics, vol. 24, pp. 2977-2988, 2009.
[5] M. Fazeli, G. M. Asher, C. Klumpner, and L. Yao, “Novel Integration of DFIG-Based Wind Generators Within Microgrids,” IEEE Trans. Energy Conversion, vol. 26, pp. 840-850, August 2011.
[6] M. Fazeli, J. B. Ekanayake, P. M. Holland and P. Igic, “Exploiting PV Inverters to Support Local Voltage:A Small-Signal Model,” IEEE Trans. on Energy Conversion, vol. 29, pp. 453-462, May 2014.
[7] J. M. Guerrero, H. Lijun, and J. Uceda, “Control of Distributed Uninterruptible Power Supply Systems,” IEEE Trans. Ind. Electron., vol. 55, pp. 2845-2859, July 2008.
[8] S. R. Nandurkar and M. Rajeev, “Design and Simulation of three phase Inverter for grid connected Photovoltaic systems,” Proceed. Of Third Biennial National Conf, NCNTE, pp. 80-83, February 2012.
[9] Y. A. R. I. Mohamed and E. F. El-Saadany, “Adaptive Decentralized Droop Controller to Preserve Power Sharing Stability of Paralleled Inverters in Distributed Generation Microgrids,” IEEE Trans. Power Electron., vol. 23, pp. 2806-2816, November 2008.
[10] R. G. Wandhare, S. Thale, and V. Agarwal, “Design of a photovoltaic power conditioning system for hierarchical control ofa microgrid,” in IEEE 40th Photovoltaic Specialist Conference (PVSC), 2014, pp. 3144-3149.
[11] J. M. Guerrero, H. Lijun, and J. Uceda, “Decentralized Control for Parallel Operation of Distributed Generation Inverters Using Resistive Output Impedance,” IEEE Trans. Ind. Electron., vol. 54, pp. 994-1004, April 2007.
[12] J. Rocabert, G. M. Azevedo, A. Luna, J. M. Guerrero, J. I. Candela, and P. Rodriguez, “Intelligent Connection Agent for Three-Phase Grid-Connected Microgrids,” IEEE Trans. Power Electronics, vol. 26, pp. 2993-3005, October 2011.
[13] R. Majumder, C. Balarko, G. Arindam, M. Rajat, L. Gerard and Z. Firuz, “Improvement of stability and load sharing in an autonomous microgrid using supplementary droop control loop,” IEEE Power and Energy Society General Meeting, pp. 1-1, July 2010.
[14] R. Majumder, A. Ghosh, G. Ledwich, and F. Zare, “Load sharing and power quality enhanced operation of a distributed microgrid,” IET Renewable Power Generation, vol. 3, pp. 109-119, March 2009.
[15] S. Anand, B. G. Fernandes, and M. Guerrero, “Distributed Control to Ensure Proportional Load Sharing and Improve Voltage Regulation in Low-Voltage DC Microgrids,” IEEE Trans. Power Electron., vol. 28, pp. 1900-1913, October 2013.
[16] Z. Yixin, Z. Fang, and S. Hongtao, “Accurate power sharing strategy for complex microgrid based on droop control method,” in IEEE ECCE Asia Downunder (ECCE Asia), 2013, pp. 344-350.
[17] A. M. Egwebe, M. Fazeli, P. Igic, and P. Holland, “Implementation and stability study of Dynamic Droop in islanded MicroGrids,” IEEE Trans. on Energy Conversion, Vol 31, no. 3, 2016.
[18] Z. Yixin, Z. Fang, L. Baoquan, and Y. Hao, “An enhanced load power sharing strategy for low-voltage microgrids based on inverse-droop control method,” in Power Electronics International Conference (IPEC-Hiroshima 2014-ECCE-ASIA), 2014, pp. 3546-3552.
[19] K. Jaehong, J. M. Guerrero, P. Rodriguez, R. Teodorescu, and N. Kwanghee, “Mode Adaptive Droop Control With Virtual Output Impedances for an Inverter-Based Flexible AC Microgrid,” IEEE Trans. on Power Electronics, vol. 26, pp. 689-701, 2011.
[20] H. Jinwei and L. Yun Wei, “An Enhanced Microgrid Load Demand Sharing Strategy,” IEEE Trans. on Power Electron., vol. 27, pp. 3984-3995, September 2012.
[21] G. Yajuan, J. C. Vasquez, J. M. Guerrero, and E. A. Coelho, “Small-signal modeling, analysis and testing of parallel three-phase-inverters with a novel autonomous current sharing controller,” in Applied Power Electronics Conference and Exposition (APEC), 2015 IEEE, 2015, pp. 571-578.
[22] G. Yajuan, J. C. Vasquez, J. M. Guerrero, “A simple autonomous current-sharing control strategy for fast dynamic response of parallel inverters in islanded microgrids,” in IEEE International Energy Conference (ENERGYCON), 2014, pp. 182-188.
[23] A. H. Etemadi, E. J. Davison, R. Iravani, “A Generalized Decentralized Robust Control of Islanded Microgrids,” IEEE Trans. Power Systems vol. 29, pp. 3102-3113, November 2014.
[24] K. De Brabandere, B. Bolsens, J. V. Keybus, A. Woyte, J. Driesen, R. Belmens, and K. U. Leuven, “A voltage and frequency droop control method for parallel inverters,” in IEEE 35th Annual Power Electronics Specialists Conference, PESC 2004, pp. 2501-2507 Vol. 4.
[25] H. Jinwei, L. W. Yun, J. M. Guerrero, B. Frede, and V. C. Juan, “An Islanding Microgrid Power Sharing Approach Using Enhanced Virtual Impedance Control Scheme”. In: IEEE Trans. on Power Electronics, 28.11 (2013), pp. 5272-5282.
[26] H. Jinwei and L. Yun Wei, “Generalized Closed-Loop Control Schemes with Embedded Virtual Impedances for Voltage Source Converters with LC or LCL Filters,” IEEE Trans. On Power Electronics, vol. 27, pp. 1850-1861, 2012.
[27] L. Zheng, C. Zhuang, J. Zhang, and X. Du, “An Enhanced Droop Control Scheme for Islanded Microgrids,” International Journal of Control and Automation, vol. 8, pp. 63-74, 2015.
[28] A. Yazdani and P. P. Dash, “A Control Methodology and Characterization of Dynamics for a Photovoltaic (PV) System Interfaced With a Distribution Network,” IEEE Trans. Power Delivery, vol. 24, pp. 1538-1551, June 2009.
[29] D. Mohan, T. M. Undeland, and W. P. Robbins, Power Electronics Converters, Applications, and Design, 3 ed.: John Wiley and Sons, 2003.
[30] M. Fazeli, P. Igic, P. Holland, R. P. Lewis, and Z. Zhuo, “Novel Maximum Power Point Tracking with classical cascaded voltage and current loops for photovoltaic systems,” in IET Conference on Renewable Power Generation (RPG 2011), pp. 1-5.
[31] K. Kelesidis, G. Adamidis, and G. Tsengenes, “Investigation of a control scheme based on modified p-q theory for single phase single stage grid connected PV system,” Inter. Conf. Clean Elect. Power pp. 535-540, June 2011.
[32] V. F. Pires, J. F. Martins, and H. Chen, “Dual-inverter for grid-connected photovoltaic system: Modeling and sliding mode control,” ScienceDirect: Solar Energy, vol. 86, pp. 2106-2115, July 2012.
[33] Z. Bo, Z. Xuesong, and C. Jian, “Integrated Microgrid Laboratory System,” IEEE Trans. on Power Systems, vol. 27, pp. 2175-2185, 2012.
[34] Z. Shuben, Y. Jian, W. Xiaomin, and Z. Ruiyi, “Dynamic power provisioning for cost minimization in islanding micro-grid with renewable energy,” in IEEE PES Innovative Smart Grid Technologies Conference (ISGT), 2014, pp. 1-5.

1. A method of managing a microgrid comprising the steps of:
providing the microgrid, the microgrid comprising a plurality of renewable distributed generators, each renewable distributed generator having a respective inverter;
determining a variable related to an available power from each of the plurality of renewable distributed generators;
controlling each inverter using a virtual impedance load sharing scheme; and,
adjusting a plurality of virtual resistance gains of each of the respective virtual impedance load sharing schemes according to a function of the variable from each respective renewable distributed generator.

2. A method of managing a microgrid according to claim 1, in which the virtual resistance gains are in the αβ frame.

3. A method according to claim 1, wherein at least one renewable distributed generator is photovoltaic.

4. A method according to claim 3, wherein all of the plurality of renewable distributed generators are photovoltaic.

5. A method according to claim 2, wherein the variable related to the available power from the photovoltaic renewable distributed generator is proportional to voltage generated by photovoltaic panels of that photovoltaic renewable distributed generator.

6. A method according to claim 5, in which the variable is a maximum active power, P_{DC-max}, which varies according to P_{DC-max} kₙV_{DC-opt}+cₙ, where V_{DC-opt} is the DC voltage at which the available power for a given irradiance is maximum.

7. A method according to claim 1, wherein the variable is an available reactive power Q_{available}, which is proportional to the square root of the difference of the squares of a power rating of each renewable distributed generator inverter and its output power.

8. A method according to any preceding claim 1, wherein the step of determining the variable comprises:
determining the maximum active power (P_{DC-max}) and the available reactive power (Q_{available}) of each of the renewable distributed generators.

9. A method according to claim 1, wherein the virtual resistance gains are proportional to the coefficients m_{pα} and n_{qβ}.

10. A method according to claim 9, wherein
$$( {m}_{p α} = \frac{{R}_{v α}}{1.5 {V}^{*}} and {n}_{q β} = \frac{{R}_{v β}}{1.5 {( {V}^{*} )}^{2}} ) .$$

11. A method according to claim 10, wherein the coefficient m_{pα} is adjusted inverse to the maximum active power (P_{DC-max}) and n_{qβ} is adjusted inverse to the available reactive power (Q_{available}) of each of the renewable distributed generators.

12. A method according to claim 11, wherein in a largely resistive microgrid,
$${m}_{p α} = \frac{Δ V}{{P}_{DC \text{-} max}} and {n}_{q β} = \frac{Δ ω}{{Q}_{avail}}$$
where ΔV and Δω are the allowed frequency and voltage deviation.

13. A method according to claim 11, wherein in a largely inductive microgrid,
$${m}_{p} = \frac{Δ ω}{{P}_{DC \text{-} max}} and {n}_{q} = \frac{Δ V}{{Q}_{available}}$$
where ΔV and Δω are the allowed frequency and voltage deviation

14. A method according to claim 1, wherein at least one of the plurality of renewable distributed generators is a wind or wave generator comprising a rotor, and wherein the variable related to the available power from each renewable distributed generator is proportional to the cube of the rotor speed.

15. A method according to claim 1, further comprising:
reducing the use of an auxiliary power generator in a largely resistive islanded microgrid energy system by adjusting the output impedance of each renewable distributed generator inverter dynamically according to
P₁m_{pα1}=P₂m_{pα2}= . . . =P_{N}m_{pαN}=ΔV
Q₁n_{qβ1}=Q₂n_{qβ2}= . . . =Q₂n_{qβN}=Δω.

16. A control system for a microgrid comprising:
a plurality of inverter controllers, wherein each inverter controller is configured to control an inverter for a renewable distributed generator, and each inverter controller is configured to adjust a droop control gain of each respective inverter according to a function of a variable from each renewable distributed generator
wherein the variable is related to an available power from each of the plurality of renewable distributed generators.

17. The control system for a microgrid according to claim 16, wherein at least one renewable distributed generator is photovoltaic.

18. A software program, which when executed is configured to carry out the method according to claim 1.

19. A method of managing a microgrid comprising the steps of:
providing the microgrid, the microgrid comprising a plurality of renewable distributed generators, each renewable distributed generator having a respective inverter;
determining a variable related to an available power from each of the plurality of renewable distributed generators; and
adjusting a plurality of gains of each respective inverter according to a function of the variable from each renewable distributed generator, wherein the gains are those utilised in one of the following load sharing schemes:
a P-V, Q-f droop scheme;
a P-f, Q-V droop with virtual impedance scheme; and,
sharing based on the ratio of virtual impedances of units.
